(19) United States
(12) Patent Application Publication
(10) Pub. No.: US 2017/0211302 A1
(43) Pub. Date: Jul. 27, 2017

(54) THREE-DIMENSIONAL ADJUSTABLE HINGE

(71) Applicant: Jianfeng LIANG, Foshan (CN)

(72) Inventor: Jianfeng LIANG, Foshan (CN)

(21) Appl. No.: 15/414,769

(22) Filed: Jan. 25, 2017

(30) Foreign Application Priority Data
Jan. 26, 2016 (CN) 201620073298.3

(51) Int. Cl. E05D 7/04; E05D 7/00; E05D 3/02

(52) U.S. Cl. CPC E05D 7/0415; E05D 3/02; E05D 7/0009; E05D 2007/0492

(57) ABSTRACT

The present application disclosed a three-dimensional adjustable hinge, includes a hinge seat, a hinge arm and a hinge cup which are connected in sequence, the hinge seat is provided with a lateral adjustment mechanism and a longitudinal adjustment mechanism, wherein: the hinge seat is provided with a vertical adjustment mechanism which can be adjusted in the same direction as the lateral adjustment mechanism and the longitudinal adjustment mechanism. The three-dimensional adjustable hinge of the present application has high stability, good reliability and is convenient for the user to adjust.

### FIELD OF THE DISCLOSURE

The present application relates to a hardware hinge, in particular, to a three-dimensional adjustable hinge which can adjust the installation location conveniently.

### DESCRIPTION OF THE RELATED ART

Hinge is a widely applied home connecting component currently, and three-dimensional adjustable hinge is widely favored by consumers because of the function of adjusting the installation location easily. In traditional structure of three-dimensional adjustable hinge, lateral and longitudinal adjustment rivets are usually provided on the hinge seat, and vertical adjustment rivets are provided on hinge arm, the users can achieve the adjustment of the hinge in three directions by adjusting the rotation of the rivets. However, in the existing three-dimensional adjustment mechanism, there are two major technical flaws. First, lateral and longitudinal adjustment rivets adjust the same direction, but the direction of vertical adjustment rivet is different with them. So when adjusting the installation location of the hinge, users need to rotate above adjustment rivets from different angles, so that the adjustment of the installation location of hinge is quite troublesome. Second, as opening and closing angles of hinge are different from each other, during some situation that opening and closing angles of hinge are smaller, even when hinge arm is fully opened, vertical adjustment rivet will still be blocked by hinge cup, resulting in that the user cannot adjust it. Therefore, the existing hinge structure still need to be further improved.

### SUMMARY

It is an object of the present application to overcome shortcomings of existing technologies and provide a three-dimensional adjustable hinge with high stability, high reliability, and convenient for the user to adjust.

The object of the present application is achieved by this way: A three-dimensional adjustable hinge, includes a hinge seat, a hinge arm and a hinge cup which are connected in sequence, the hinge seat is provided with a lateral adjustment mechanism and a longitudinal adjustment mechanism, wherein: the hinge seat is provided with a vertical adjustment mechanism which can be adjusted in the same direction as the lateral adjustment mechanism and the longitudinal adjustment mechanism.

The vertical adjustment mechanism includes a side plate provided at the lower part of the hinge seat, an adjustment chip provided inside the side plate, and an adjustment bolt provided on the hinge seat for pulling the adjustment chip up and down, the side plate is in sliding connection with the hinge arm, the adjustment chip is fixed on hinge arm.

A chute is provided on the outer side of the side plate, a sliding table which matches with the chute is provided on the hinge arm.

The means of engagement between the adjustment chip and the hinge arm can be pin connection, buckle connection, or welding.

The hinge seat is provided with a guide hole into which the adjustment chip is inserted.

The adjustment chip is provided with a lateral connection part, the lateral connection part and the adjustment bolt are connected by threaded connection or clamping connection.

The adjustment bolt and the hinge seat are connected by clamping connection or threaded connection.

The side plate is provided with a through hole which corresponds to the position of the adjustment chip.

The adjustment chip is provided with a convex plate which can be pressed against the hinge.

The beneficial effects of the application is: the hinge seat is provided with a vertical adjustment mechanism which can be adjusted in the same direction as the lateral adjustment mechanism and the longitudinal adjustment mechanism, which can replace traditional direction staggered three-dimensional adjustment. By setting the adjustment direction of three-dimensional adjustment component uniformly, users can adjust the installation location of the hinge in three dimensions by simply adjusting in one direction, thereby greatly improving the ease of installation of the hinge. Meanwhile, by adjustment mechanisms with unified direction mentioned above, completely eliminate the phenomenon that adjustment mechanisms are blocked because of the smaller opening and closing angle of the hinge, to ensure the stability and reliability of the hinge.

### BRIEF DESCRIPTION OF THE DRAWINGS

FIG. 1 is a schematic structural diagram of the present application.

FIG. 2 is a schematic structural diagram of adjustment bolt, hinge seat and vertical adjustment mechanism at separation state.

FIG. 3 is a schematic structural diagram of another embodiment of FIG. 2.

FIG. 4 is a schematic structural diagram of hinge seat, hinge arm and vertical adjustment mechanism at separation state.

FIG. 5 is a schematic structural diagram of the second embodiment of FIG. 4.

FIG. 6 is a schematic structural diagram of the third embodiment of FIG. 4.

FIG. 7 is a schematic structural diagram that adjustment chip and lateral connection part are connected.

FIG. 8 is a schematic structural diagram that convex plate, adjustment chip and lateral connection part are connected.

### DETAILED DESCRIPTION

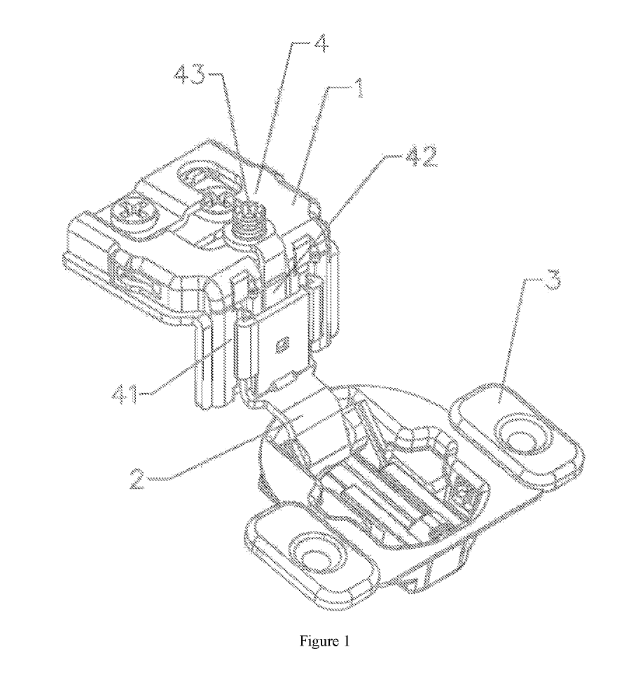

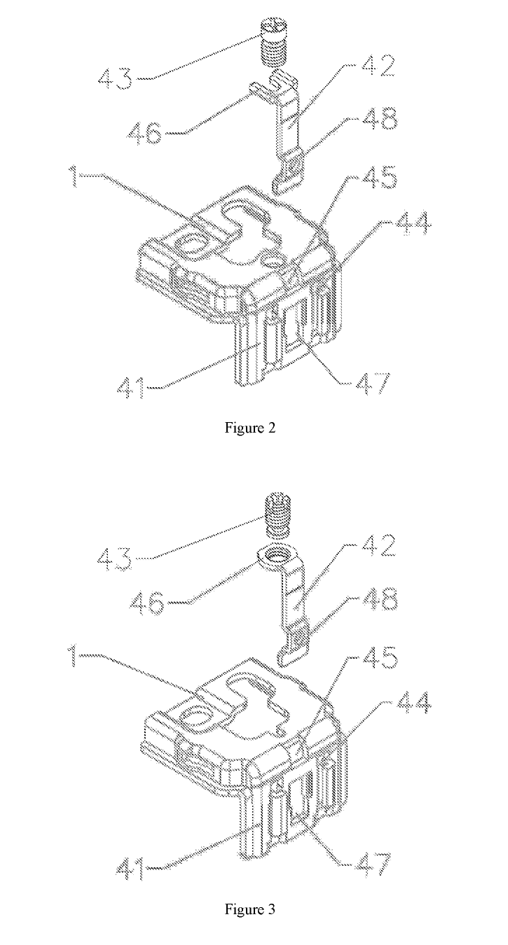

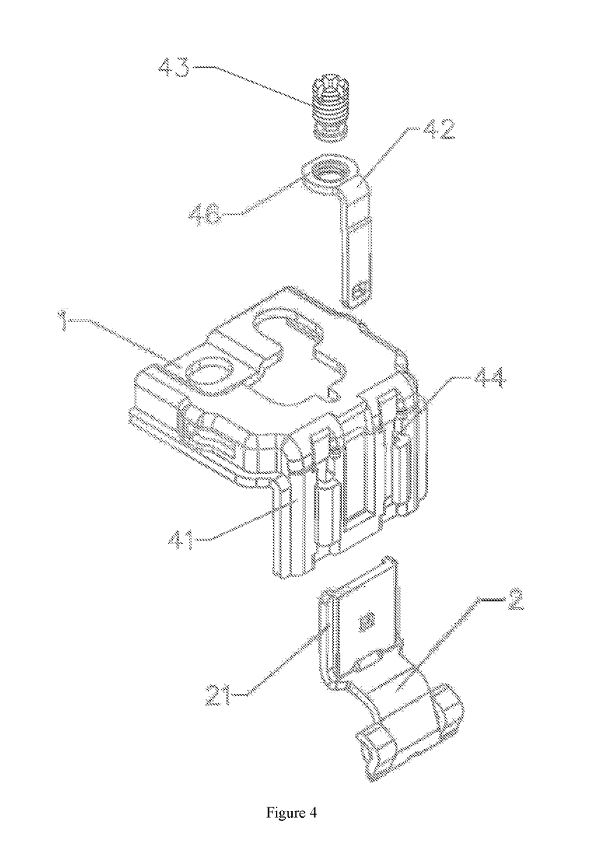

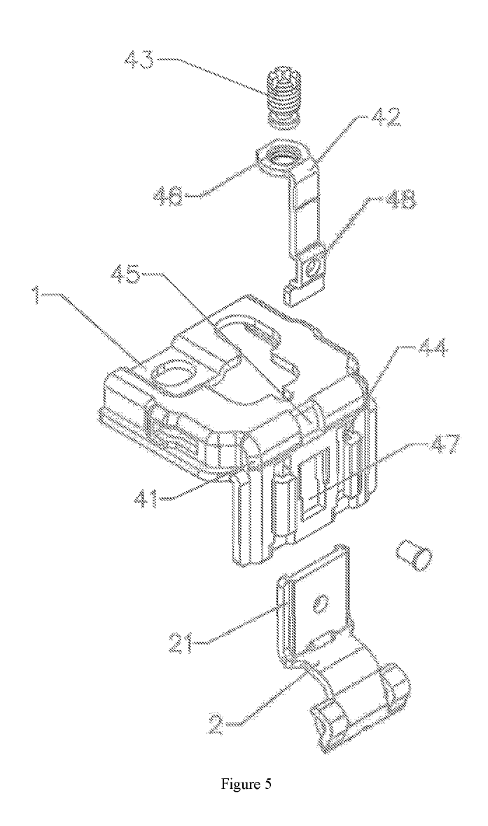

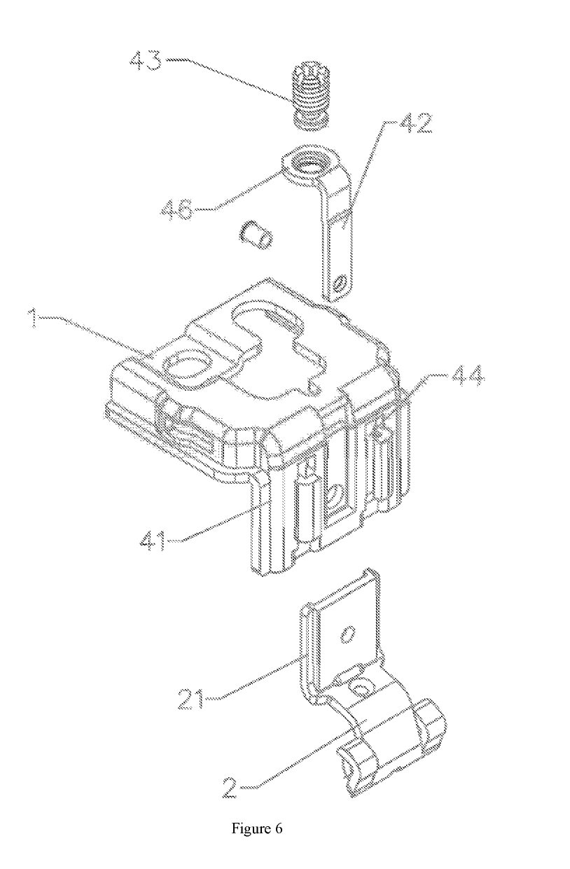

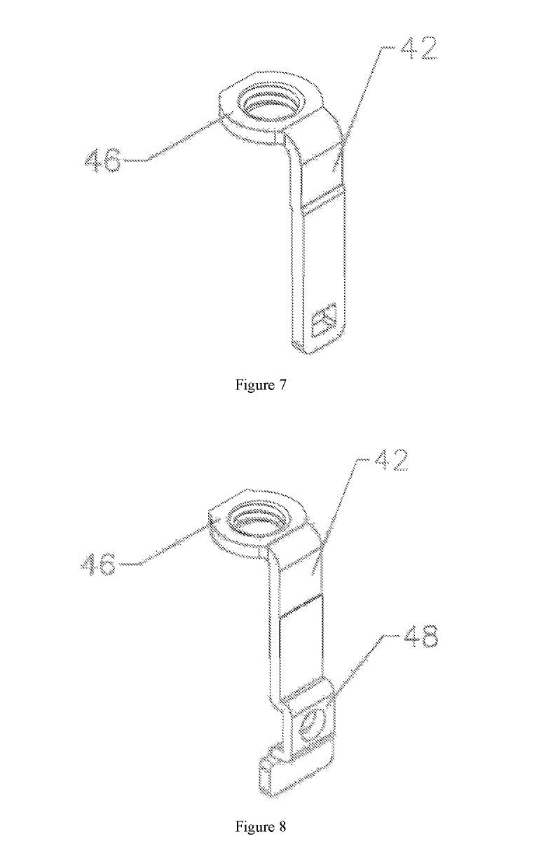

Following is the further description of the present application with reference to the attached drawings. Referring to FIG. 1 to FIG. 8, the three-dimensional adjustable hinge of the present application includes hinge seat 1, hinge arm 2 and hinge cup 3, and hinge seat 1, hinge arm 2 and hinge cup 3 are connected in sequence. The hinge seat 1 is provided with lateral adjustment mechanism, longitudinal adjustment mechanism and vertical adjustment mechanism 4, and the above three adjustment mechanisms can adjust the lateral, longitudinal and vertical location of the hinge on the same direction. With the characteristics that three adjustment mechanisms can be adjusted on the same direction, users only need to adjust in one direction, three dimensional adjustment can be performed on the installation location of the hinge.

The vertical adjustment mechanism 4 of the present application includes side plate 41, adjustment chip 42 and adjustment bolt 43, wherein side plate 41 is provided on the lower part of hinge seat 1, side plate 41 and hinge seat 1 can be fixed to the lower part of hinge seat 1 by one-time processing forming, welding or other means, and adjustment chip 42 is provided on the inner side of side plate 41, which can slide up and down along the side plate 41, and the adjustment bolt 43 is provided on the hinge seat 1, which can pull adjustment chip 42 up and down. Side plate 41 is in sliding connection with hinge arm 2, adjustment chip 42 is fixed on hinge arm 2. The means of engagement between adjustment chip 42 and hinge arm 2 can be pin connection, buckle connection, welding or other means. In the pin connection, the insertion position of the pin may be in one side of hinge arm 2, and may be also in one side of adjustment chip 42. The hinge arm 2 can slide up and down along the side plate 41 by the pulling of the adjustment chip 42 by the adjustment bolt 43, to achieve vertical adjustment of the hinge. Chute 44 is provided on the outer side of side plate 41, sliding table 21 which matches with the chute 44 is provided on the hinge arm 2. With the matching connection of chute 44 and sliding table 21, hinge arm 2 slides smoother and more stable. In order to improve the stability of adjustment chip 42 sliding on hinge seat 1, hinge seat 1 is provided with guide hole 45 into which adjustment chip 42 is inserted, adjustment chip 42 can slide back and forth along the vertical direction of side plate 41 through guide hole 45.

Further, in order to allow adjustment chip 42 to be moved up and down under pulling of adjustment bolt 43, adjustment chip 42 can be provided with lateral connection part 46, and by the connection relation among adjustment bolt 43, lateral connection part 46 and hinge seat 1, adjustment bolt 43 can drive adjustment chip 42 to move when rotating. The detailed structure is that lateral connection part 46 and adjustment bolt 43 use threaded connection, adjustment bolt 43 and hinge seat 1 use clamping connection, or lateral connection part 46 and adjustment bolt 43 use clamping connection, adjustment bolt 43 and hinge seat 1 use threaded connection.

In addition, the side plate 41 is provided with a through-hole 47 which corresponds the location of adjustment chip 42, to allow adjustment chip 42 to be fixedly connected to hinge arm 2 via through-hole 47. And the adjustment chip 42 may be provided with a convex plate 48 which can be pressed against hinge arm 2, to increase the stability of the connection of adjustment chip 42 and hinge arm 2 by increasing the contact area thereof.

Above-mentioned detailed embodiment is only a specific embodiment with better effect, any three-dimensional adjustable hinge which is same or equivalent with the structure, will be within the scope of present application.

What is claimed is:

1. A three-dimensional adjustable hinge, comprising:
a hinge seat, a hinge arm and a hinge cup which are connected in sequence, the hinge seat is provided with a lateral adjustment mechanism and a longitudinal adjustment mechanism, wherein: the hinge seat is provided with a vertical adjustment mechanism which can be adjusted in the same direction as the lateral adjustment mechanism and the longitudinal adjustment mechanism.

2. The three-dimensional adjustable hinge of claim 1, wherein: the vertical adjustment mechanism includes a side plate provided at the lower part of the hinge seat, an adjustment chip provided inside the side plate, and adjustment bolt provided on the hinge seat for pulling the adjustment chip up and down, the side plate is in sliding connection with the hinge arm, the adjustment chip is fixed on hinge arm.

3. The three-dimensional adjustable hinge of claim 2, wherein: a chute is provided on the outer side of the side plate, a sliding table which matches with the chute is provided on the hinge arm.

4. The three-dimensional adjustable hinge of claim 2, wherein: the means of engagement between the adjustment chip and the hinge arm is one of a pin connection, buckle connection, or welding.

5. The three-dimensional adjustable hinge of claim 2, wherein: the hinge seat is provided with a guide hole into which the adjustment chip is inserted.

6. The three-dimensional adjustable hinge of claim 2, wherein: the adjustment chip is provided with a lateral connection part, the lateral connection part and the adjustment bolt are connected by threaded connection or clamping connection.

7. The three-dimensional adjustable hinge of claim 2, wherein: the adjustment bolt and the hinge seat are connected by clamping connection or threaded connection.

8. The three-dimensional adjustable hinge of claim 2, wherein: the side plate is provided with a through hole which corresponds to the position of the adjustment chip.

9. The three-dimensional adjustable hinge of claim 2, wherein: the adjustment chip is provided with a convex plate which can be pressed against the hinge.
